(19) United States
(12) Patent Application Publication
(10) Pub. No.: US 2013/0284490 A1
(43) Pub. Date: Oct. 31, 2013

(54) ELECTRICAL WIRING SYSTEM AND METHOD

(71) Applicant: Mark E. Goodson, Corinth, TX (US)

(72) Inventor: Mark E. Goodson, Corinth, TX (US)

(21) Appl. No.: 13/455,686

(22) Filed: Apr. 25, 2012

(51) Int. Cl. H01B 9/00

(52) U.S. Cl. 174/113 R

(57) ABSTRACT

An electrical wiring system/method that overcomes dangers associated with transient voltages in electrical system wiring harnesses by controlling the voltage differential between NEUTRAL and GROUND wires with respect to HOT wire(s) within an electrical cable during TVSS faulting conditions is disclosed. This voltage control minimizes the temporary voltage rise in chassis potential of a grounded appliance that may occur during TVSS operation or during an internal equipment short or GROUND fault condition. The system/method accomplishes this goal by asymmetrically configuring the wiring conductance paths associated with the NEUTRAL or GROUND conductors within the wiring harness and in some preferred embodiments configures the NEUTRAL and GROUND wires to have larger cross sectional areas than the HOT wire(s). The system/method may in some preferred embodiments be advantageously implemented in commercial/residential applications involving alternating current (AC) power distribution and the like.

### BACKGROUND OF THE INVENTION

1. Technical Field of the Invention

The present invention relates generally to wiring or cabling carrying electrical power or fault current to or from appliances and electrical devices and is particularly suited for use with appliances and devices that are protected by transient voltage surge suppressers.

2. Description of the Related Art

Modern household appliances such as, for example, audio and video equipment, and commercial equipment have solid state circuits or other sensitive circuits that are subject to damage caused by electrical transients. As used herein, the term appliance refers to any device that receives electrical power. Currently, in an effort to minimize the effects of transient voltages, variations of a class of device known as a Transient Voltage Surge Suppressor (TVSS) are used. Such devices are used in, for example, consumer and industrial electronics, automotive electronics, and telecom systems as well as commercially available surge protector strips.

The main component within a TVSS is typically a voltage clamping Metal Oxide Varistor (MOV). Additionally, other types of voltage clamping devices such as a gas tubes or Zener diodes are used. An MOV has a non-linear Voltage and Current (V-I) curve that has a very high resistance when the voltage across it is small compared to its threshold voltage. Conversely, when the voltage across an MOV is high compared to its threshold voltage, the MOV has a low resistance and allows current to pass through it, thus providing a shunt for transient voltages above the MOV's threshold voltage. In such situations, for example, an MOV can be placed between HOT and NEUTRAL conductors, between HOT and GROUND conductors, and/or between NEUTRAL and GROUND conductors. When the MOV threshold voltage is exceeded, such as when a large enough transient occurs, the nonlinear characteristics of the MOV allows a fault current, possibly in the many hundreds of amps (or more) to temporarily flow. The voltage drop of the wiring feeding the MOV, which temporarily carries this fault current, may cause the output voltage seen by the appliance or sensitive circuit to drop in turn.

For example, if an appliance that has an MOV protecting it that is placed across the HOT line and NEUTRAL at the appliance, and a transient voltage occurs, the flow of current may cause a voltage drop across the HOT feeder conductor to the MOV and a corresponding voltage drop across the NEUTRAL conductor that handles the return current. The net effect is that the NEUTRAL voltage at the appliance is no longer zero volts (with respect to GROUND), and thus presents a shock hazard.

If an MOV is placed, instead, between HOT and GROUND and a transient occurs, a similar voltage drop can occur on the GROUND return path. In this situation, the GROUND may float to a higher voltage. For example, on a grounded appliance, where that appliance contains or is connected to a sensitive electronic circuit, such as, for example, a data circuit, the increase in the GROUND voltage can damage the circuit.

The current method of manufacturing cable assemblies such as type NM (nonmetallic), for example, calls for equal resistance in all conductors (HOT, NEUTRAL, and GROUND) or for the GROUND conductor to be of a smaller diameter (and having a higher resistance) with respect to the other conductors. For conductors made of the same material, these dimensions will reduce in equal voltage drops on conductors that are equal in diameter, or in a greater voltage rise on the GROUND leg for those cable assemblies with reduced diameter GROUND legs. Thus, current commercially available products are not well suited for use with circuits protected by modern TVSS devices.

An additional limitation of current cabling systems is that the circuit breaker that protects the MOV (the breaker that is part of the residential or commercial wiring) cannot always respond rapidly if the MOV begins to fail. In situations such as these, the MOVs can overheat and may even cause a fire. For example, when a 14 AWG wire is feeding an appliance, and the MOV within the appliance starts to fail, the MOV fault current will largely be a function of the two conductors (HOT and NEUTRAL) that are part of the branch circuit wiring. Under many circumstances, the fault current will be insufficient to cause a typical Thermal-Magnetic (TM) circuit breaker to trip.

Therefore, in order to reduce the risk of electrical shock, fire, and potential damage to equipment where TVSS devices are used, a new type of cabling is needed.

Accordingly, the objectives of the present invention are (among others) to circumvent the deficiencies in the prior art and affect the following objectives:
Provide for an electrical wiring system and method that reduces voltage transients in an electrical appliance chassis serviced by a TVSS device.
Provide for an electrical wiring system and method that reduces voltage transients in an electrical appliance chassis in the event of a NEUTRAL/GROUND fault within the appliance.
Provide for an electrical wiring system and method that is compatible with existing NM electrical wiring standards.
Provide for an electrical wiring system and method that permits rapid circuit breaker activation in the event of TVSS activation and/or a NEUTRAL/GROUND fault in an electrical appliance.

While these objectives should not be understood to limit the teachings of the present invention, in general these objectives are achieved in part or in whole by the disclosed invention that is discussed in the following sections. One skilled in the art will no doubt be able to select aspects of the present invention as disclosed to affect any combination of the objectives described above.

### SUMMARY OF THE INVENTION

### System Overview

The present invention overcomes the disadvantages of currently available cabling and wiring when used in conjunction with transient voltage suppressers and provides for cabling designed such that a HOT wire is asymmetrically conductive (sized differently, etc.) with respect to the NEUTRAL and the GROUND wires. In one embodiment, the NEUTRAL and GROUND wires are several wire sizes larger in diameter than the HOT wire. This minimizes the voltage differential between NEUTRAL and GROUND wires during TVSS faulting conditions. Additionally, this helps to minimize the temporary voltage rise on the chassis of a grounded appliance that can occur during both TVSS operation or during an internal short or fault condition.

### Method Overview

The present invention system may be utilized in the context of an overall electrical wiring method, wherein the electrical wiring system described previously operates in conjunction with a method in which the electrical wiring system described above having reduced NEUTRAL and/or GROUND wire resistivity is connected to one or more appliances having a TVSS device to reduce appliance chassis voltage spikes in the event of TVSS activation and/or a NEUTRAL/GROUND fault within the appliance.

### BRIEF DESCRIPTION OF THE DRAWINGS

For a fuller understanding of the advantages provided by the invention, reference should be made to the following detailed description together with the accompanying drawings wherein:

FIG. 1 illustrates a system block diagram of a preferred exemplary system embodiment of the present invention used in the context of conventional commercial/residential wiring application;

FIG. 2 illustrates a method flowchart of a preferred exemplary method embodiment of the present invention;

FIG. 3 illustrates a perspective view of prior art NM electrical wiring cable;

FIG. 4 illustrates a side plan view of prior art NM electrical wiring cable;

FIG. 5 illustrates a side plan view of a presently preferred exemplary embodiment of the present invention system;

FIG. 6 illustrates a perspective view of a presently preferred exemplary embodiment of the present invention as applied to a hand-drill appliance;

FIG. 7 illustrates a perspective view of a presently preferred exemplary embodiment of the present invention as applied to a surge protector electrical outlet strip;

FIG. 8 illustrates a system block diagram of a preferred exemplary system embodiment of the present invention.

All figures are drawn for ease of explanation of the basic teachings of the present invention only; the extensions of the figures with respect to number, position, relationship, and dimensions of the parts to form the preferred embodiment will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

### DETAILED DESCRIPTION OF THE INVENTION

While this invention is susceptible of embodiment in many different forms, there is shown in the drawings and will herein be described in detailed preferred embodiment of the invention with the understanding that the present disclosure is to be considered as an exemplification of the principles of the invention and is not intended to limit the broad aspect of the invention to the embodiment illustrated.

The numerous innovative teachings of the present application will be described with particular reference to the presently preferred embodiment, wherein these innovative teachings are advantageously applied to the particular problems of an ELECTRICAL WIRING SYSTEM AND METHOD. However, it should be understood that this embodiment is only one example of the many advantageous uses of the innovative teachings herein. In general, statements made in the specification of the present application do not necessarily limit any of the various claimed inventions. Moreover, some statements may apply to some inventive features but not to others.

### Wiring Conductor not Limitive

The present invention anticipates a wide variety of wire types may be used to implement the various aspects of the invention and makes no limitation on the type of wiring conductor that may be used to implement these functions.

### Wire Sizing not Limitive

The present invention anticipates a wide variety of wire sizes may be used to implement the various aspects of the invention and makes no limitation on the wire conductor sizes that may be used to implement these functions. The specific wire sizes used herein are given for purpose of example only and do not limit the scope of the claimed invention. Wire sizes depicted herein are relative, and may be equally applied to #10 AWG, #12 AWG, and #14 AWG baseline cable wire sizes.

### TVSS not Limitive

The present invention anticipates that a wide variety of Transient Voltage Surge Suppressor (TVSS) technologies may be used to implement various embodiments of the present invention and makes no limitation on the particular type of TVSS that may be used to construct various invention embodiments.

### System Overview

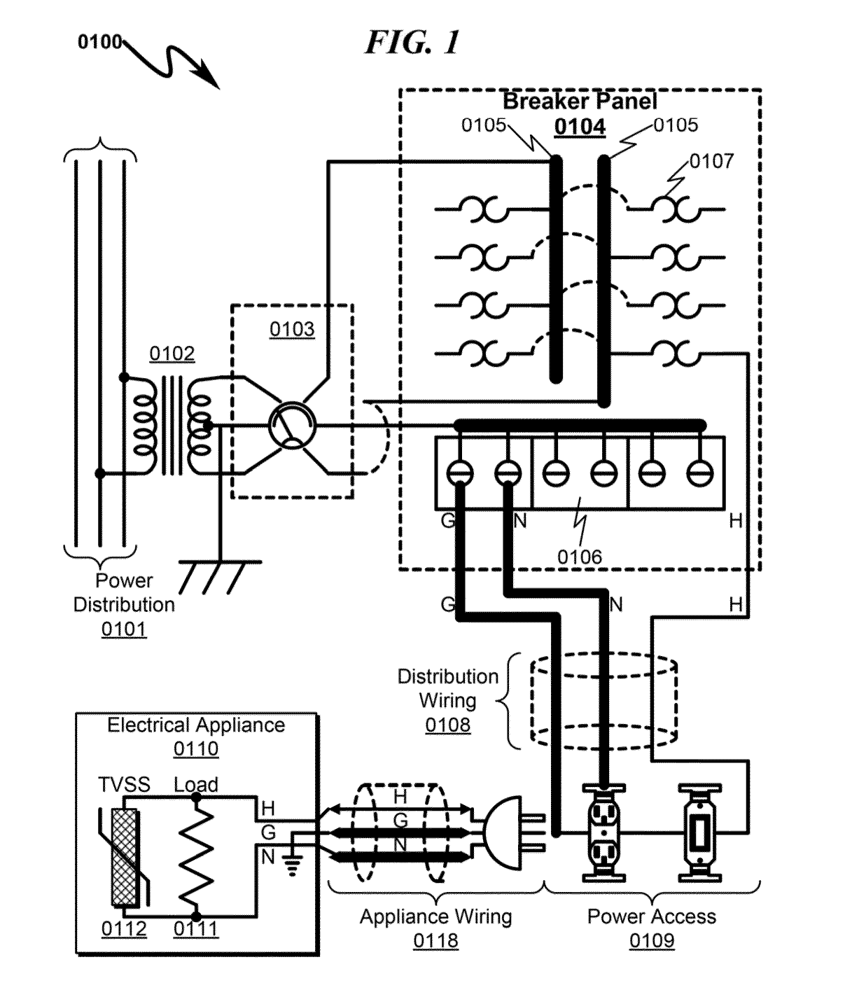

The present invention may be best understood by inspection of the system overview depicted in FIG. 1 (0100) wherein a preferred exemplary commercial/residential power distribution system embodiment is depicted. Here power is provided from a three-phase distribution power infrastructure (0101) to supply a step-down transformer (0102) connected to a metering system (0103) at the service entrance of a building or other structure. Power from the metering system (0103) is supplied to a breaker panel (0104) comprising internal HOT bus bars (0105), a NEUTRAL/GROUND bus bar (0106), and circuit breakers (0107) connected to one or more of the HOT bus bars (0105).

Power flows from the circuit breakers (0107) (supplying power from the HOT wire leg of the transformer (0102)) and the NEUTRAL wire through distribution wiring (0108) to switches/outlets that represent the power access point (0109) for electrical appliances (0110) to derive power. In this context the electrical appliances comprise an internal load (0111) and TVSS (0112) device to suppress load voltage transients. Appliance wiring (0118) comprising wires and/or connectors may be part of the electrical appliance (0110) configuration and as such serves as the mechanical/electrical interface to the power access point (0109).

Within this context the present invention teaches that reduction of the wiring resistance in the distribution wiring (0108) and/or appliance wiring (0118) can affect a reduction in chassis potential spikes due to electrical faults within the electrical appliance (0110) caused by either activation of the TVSS device (0112) and/or a load/ground fault resulting in either application of HOT supply voltage to the chassis of the electrical appliance (0110). Decreased wiring resistance in this context can be achieved using a variety of methods, with one preferred method being increasing the wiring cross section of the NEUTRAL and/or GROUND wires in the distribution wiring (0108) and/or appliance wiring (0118).

### Method Overview

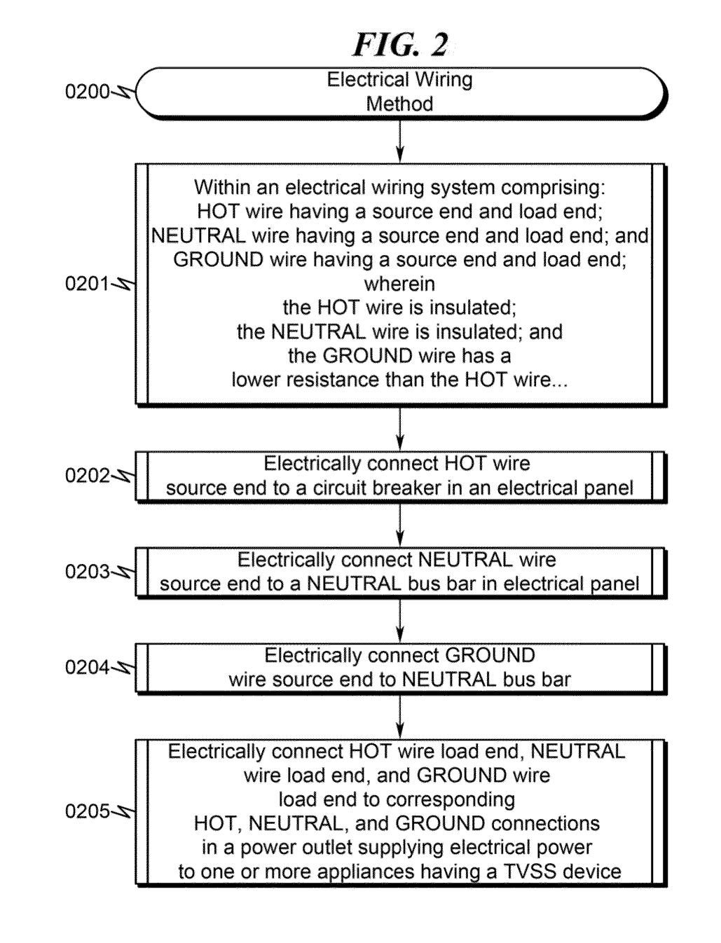

The present invention method may be seen in an overview context as generally illustrated in the flowchart of FIG. 2 (0200), and can be generally described as an electrical wiring method that comprises the following method steps:

Within an electrical wiring system comprising:
HOT wire having a source end and load end; NEUTRAL wire having a source end and load end; and GROUND wire having a source end and load end;
wherein the HOT wire is insulated; the NEUTRAL wire is insulated; and the GROUND wire has a lower resistance than the HOT wire . . . (0201);
Electrically connect the HOT wire source end to a circuit breaker in an electrical panel (0202);
Electrically connect the NEUTRAL wire source end to a NEUTRAL bus bar in electrical panel (0203);
Electrically connect the GROUND wire source end to NEUTRAL bus bar (0204);
Electrically connect the HOT wire load end, NEUTRAL wire load end, and GROUND wire load end to the corresponding HOT, NEUTRAL, and GROUND connections in a power outlet supplying electrical power to one or more appliances having a TVSS device (0205).

One skilled in the art will recognize that these method steps may be augmented or rearranged without limiting the teachings of the present invention.

### System Detailed Description

The present invention described below generally teaches a system and method for electrically connecting to an electrical appliance that is protected by a TVSS circuits device via use of asymmetrically conductive NEUTRAL and GROUND wiring.

### Prior Art NM Wiring

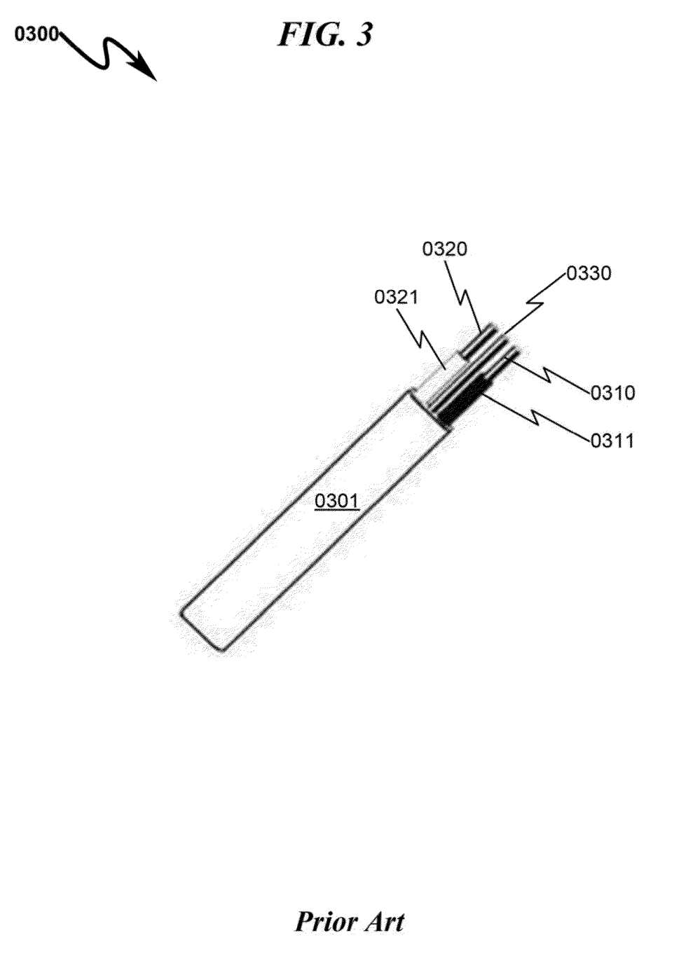

FIG. 3 (0300) depicts a perspective view of currently available NM (nonmetallic) wiring cable. Nonmetallic-sheathed cable is one of the most widely used cables for branch circuits and feeders in residential and commercial systems. Such cable is commonly and generally called ROMEX® by electrical construction personnel, as this is the trade name under which the cable is sold by General Cable Corporation. Type NM cable has an overall covering of fibrous or plastic material which is flame-retardant and moisture-resistant. Type NMC is similar, but the overall covering is also fungus-resistant and corrosion-resistant. The letter “C” indicates that it is corrosion-resistant.

This NM wiring cable is composed of a polymer jacket (0301) covering an insulated HOT (0310) and NEUTRAL (0320) wire with an exposed GROUND wire (0330). Insulation (0311, 0321) covers the HOT (0310) and NEUTRAL (0320) wires respectively. The GROUND wire (0330) is generally not insulated as it is not normally designed to carry current in this configuration absent an equipment fault condition.

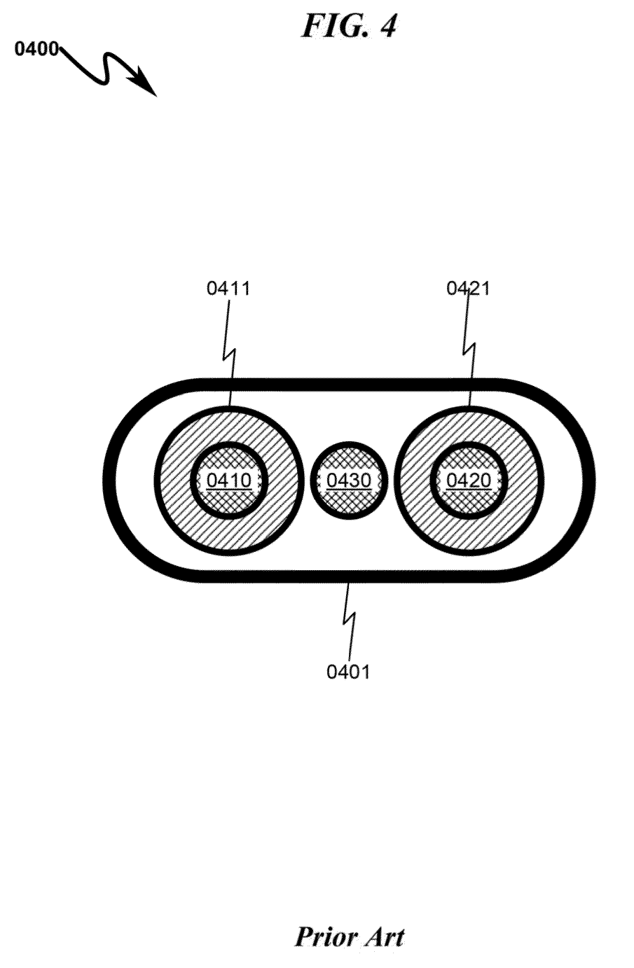

FIG. 4 (0400) is a side plan view of a cross section of currently available NM cable as previously depicted in FIG. 3 (0300). The outer jacketing (0401) is a typically a polymer jacket, which has internally conductors (0410, 0420, 0430). The HOT wire conductor (0410) is commonly #14 AWG (American Wire Gauge) corresponding to the diameter of the cross section of the conductor. The HOT wire (0410) has about it a layer of insulation (0411), normally made of PVC thermoplastic. The NEUTRAL conductor (0420) also has a diameter referred to in the trade as #14 AWG. The NEUTRAL conductor (0420) has about it an insulating thermoplastic layer (0421), similar to layer (0411) with respect to the HOT wire conductor (0410). The GROUND conductor (0430) also has a diameter referred to as #14 AWG. In the instance of commercially available cabling, the GROUND conductor (0430) is typically not individually insulated by PVC thermoplastic. Conductors (0410, 0420, 0430) are typically made of copper or a copper alloy.

### Present Invention Preferred Exemplary Embodiment

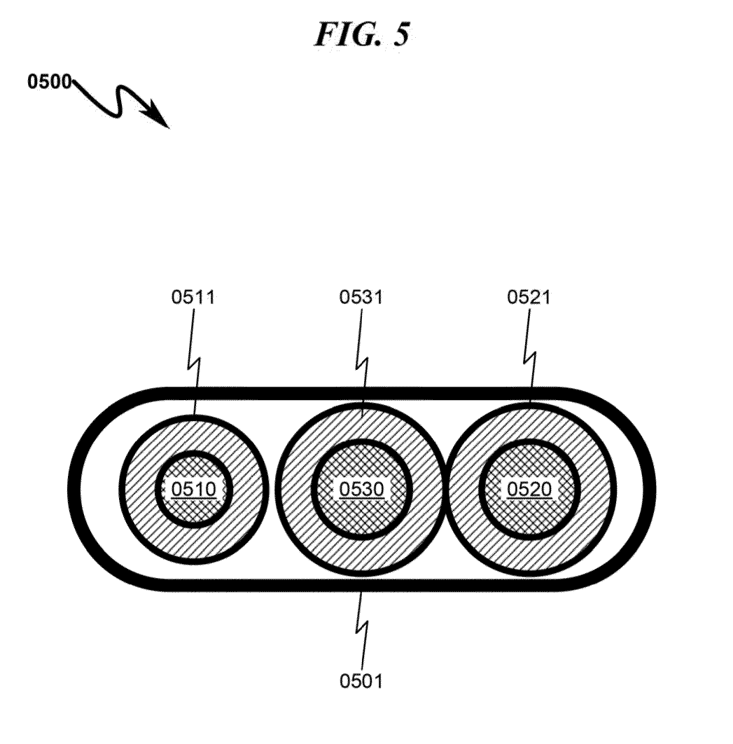

FIG. 5 (0500) is a side plan view of a cross section of a preferred exemplary embodiment of the present invention implementing asymmetrical electrical cable wire sizing. The outer jacketing (0501) is a polymer jacket that contains a number of wires. In this presently preferred exemplary embodiment of the present invention cable system, the cable contains three insulated wires: a HOT wire (0510), a NEUTRAL wire (0520), and a GROUND wire (0530). In this embodiment the HOT wire (0510) has a nominal diameter of approximately 0.0641 inches, and is commonly referred to as #14 AWG. The HOT wire (0510) has about it a layer of insulation (0511). The NEUTRAL wire (0520) has a diameter of 0.102 inches referred to in the trade as #10 AWG. The NEUTRAL wire (0520) has about it an insulating layer (0521). The GROUND wire (0530) has a nominal diameter of 0.102 inches, and is referred to as #10 AWG. The GROUND wire (0530) has about it a layer of insulation (0531).

In this presently preferred exemplary embodiment, the insulation around the wires (0511, 0521, 0531) is made of PVC thermoplastic although other types of insulation are also envisioned. Likewise, the polymer jacket (0501) may be made up of other material. In the current embodiment, the HOT (0510), NEUTRAL (0520), and GROUND (0530) wires are made of copper. Other conductors, including but not limited to aluminum and copper alloys, are also envisioned.

Although FIG. 5 (0500) depicts a wiring cable containing one HOT wire, one skilled in the art will appreciate that that cable may contain any number of HOT wires to serve a variety of functions such as, for example, wiring of a three-way light switch or distributing three-phase power. Additionally, although FIG. 5 (0500) shows a cable where the HOT (0510), GROUND (0530), and NEUTRAL (0520) wires are situated linearly with respect to each other, the wires may be situated in any order and need not be oriented linearly.

### Theory of Operation

To minimize the negative effects of voltage transients or surges, the resistance of the NEUTRAL path is reduced by, for example, increasing the diameter of the NEUTRAL wire with respect to the HOT wire. With the reduced resistance, increased current will flow, resulting in a more rapid tripping of a TM breaker and reducing the chances for fire when the TVSS/MOV begins to fail.

### Portable Equipment Electrical Cabling

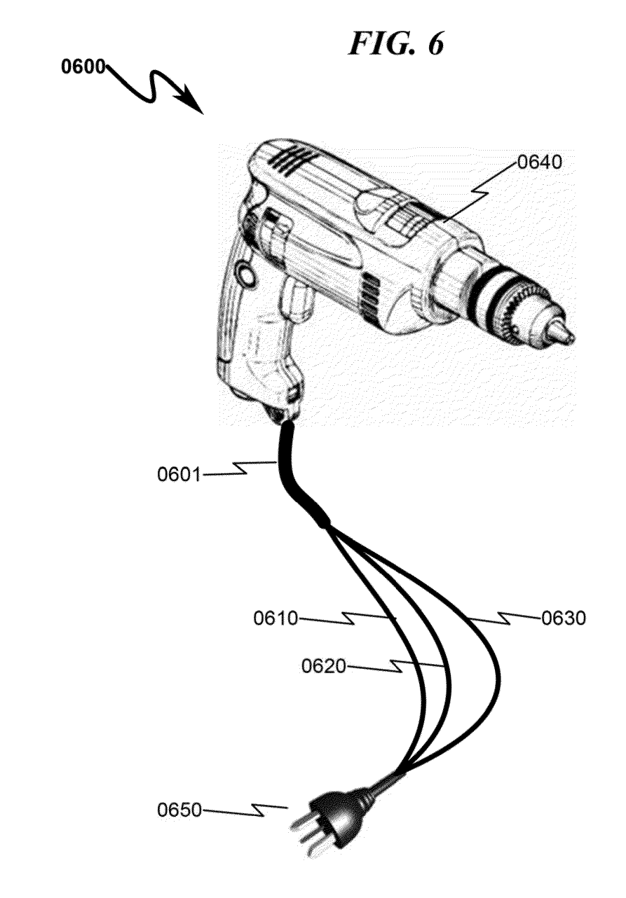

While the above descriptions have concerned themselves with cabling that once installed is stationary, the same techniques could also be used for both appliance line cord and extension cords. Referencing FIG. 6 (0600) illustrates a perspective view of an embodiment of the invention used in conjunction with a hand-drill appliance. The embodiment of the invention in this figure shows a hand-drill (0640) with an asymmetrical electrical cable (0601) supplying its power. Three conductors: a HOT wire (0610), a NEUTRAL wire (0620), and a GROUND wire (0630) are shown in a breakaway view. The cabling (0601) is also connected to a three-prong grounded AC plug (0650) to receive electrical power from a power outlet. In this embodiment, both the NEUTRAL wire (0620) and the GROUND wire (0630) are at least four AWG sizes less than the HOT wire (0610). Such a hand drill may be used to drill a hole in a wall. If the bit of the drill were to encounter a live wire hidden behind the wall, the larger GROUND wire (0630) would allow a greater fault current to flow from the energized bit to GROUND, speeding the action of an overcurrent protection device and causing a lower voltage to be present on the chassis of the tool. Similarly, the rise in voltage as seen by the person holding the drill on the drill chassis (0640) as fault current flows will be lessened as the lower GROUND resistance keeps the voltage on the chassis closer in value to GROUND thus reducing the severity of electrical shock.

### Same Protector Application

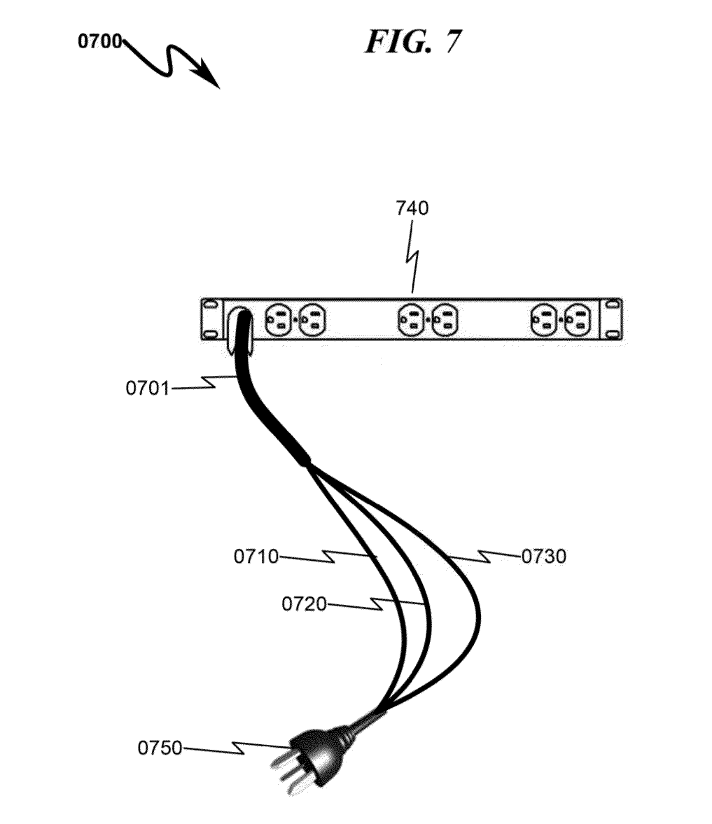

This invention also has application with common surge protector strips. FIG. 7 (0700) is a perspective view of an embodiment of the invention used in conjunction with a surge protector strip. The body of the surge protector (0740) contains one or more TVSS devices. The asymmetrical electrical cabling (0701) in this embodiment contains three conductors, a HOT wire (0710), a NEUTRAL wire (0720), and a GROUND wire (0730) shown in breakaway view. In this embodiment, both the NEUTRAL wire (0720) and the GROUND wire (0730) are at least four AWG sizes less than the HOT wire (0710). The cabling (0701) is also connected to a three-prong grounded AC plug (0750) to receive electrical power from a power outlet.

### Exemplary Building Wiring Application (0800)

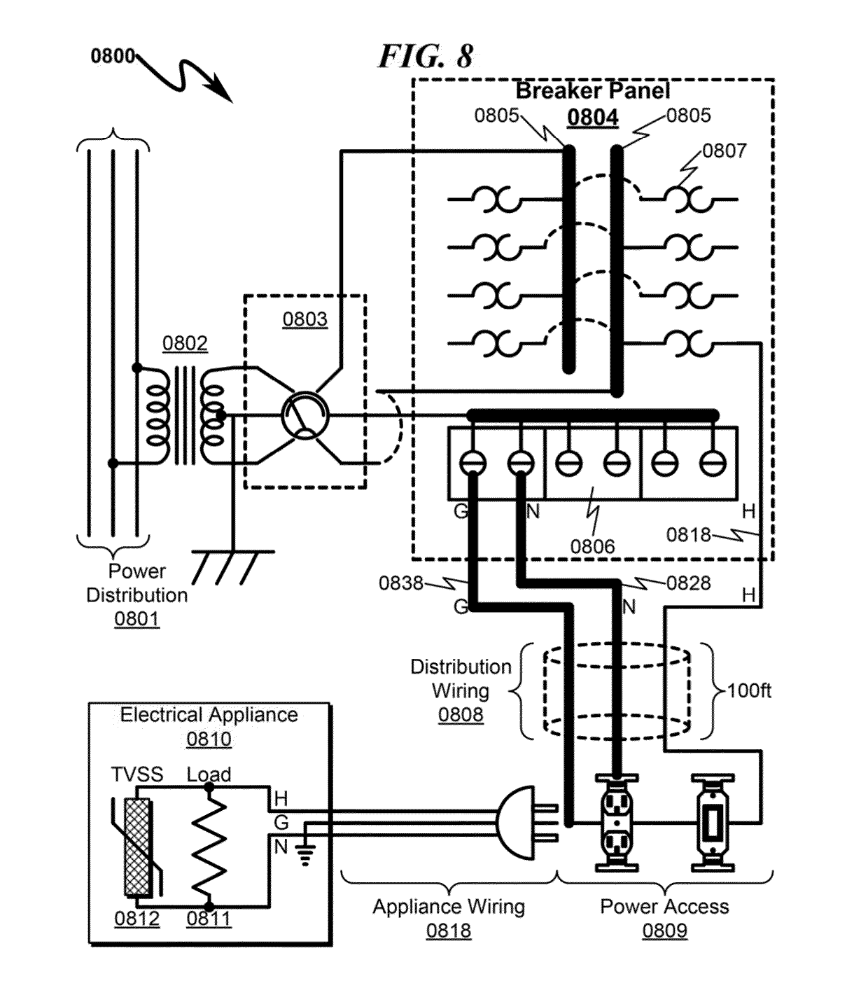

FIG. 8 (0800) is a schematic diagram showing house wiring connecting to an appliance containing a TVSS circuit. In this configuration, power is supplied to a house from an external transformer (0802) and runs through a breaker box (0804) protected by a TM breaker (0807). Electrical cabling is run from the breaker box (0804) to a power outlet (0809) which supplies the power for an appliance (0810) having a load (0811) protected by a TVSS (0812). The NEUTRAL wire (0828) and the GROUND wire (0838) are electrically connected in the breaker box at the NEUTRAL bar (0806).

As an example of one mode of operation, if a load (0811) in an appliance (0810) (or other TVSS protected circuit) is 100 feet from the breaker panel (0804) when there is a fault (whether from TVSS action or other fault) causing 200 amperes of fault current to temporarily flow between the HOT wire (0831) and the GROUND wire (0838), then the voltage drop as seen by the load (0811), according to Ohm's law, could be 50 volts for #14 AWG copper wire such as the currently available cabling illustrated in FIG. 3 (0300) and FIG. 4 (0400). However, by using the cabling of a preferred embodiment of the present invention as generally depicted in FIG. 5 (0500), the voltage drop, as seen by the load (0811), can be reduced to approximately 20 volts where the fault current is only carried by the GROUND wire (0838). In other cases, which are typical, the voltage drop is even smaller when the fault current is carried by both the GROUND wire and the NEUTRAL wire.

### Alternate System Embodiments

While the present system has been depicted in terms of a baseline #14 AWG wiring conductor for the HOT wire, other embodiments of the present invention may utilize #12 or #10 wire for the HOT conductor, with similar upsizing of the NEUTRAL/GROUND conductors. Furthermore, while many preferred embodiments of the present invention utilize NEUTRAL/GROUND conductors that are four AWG sizes larger than the HOT conductor, other preferred embodiments utilize NEUTRAL/GROUND conductors that are two AWG sizes larger than the HOT conductor. This wiring size selection will be highly application dependent.

Furthermore, while the present invention anticipates that circular conductors may be used in many embodiments, the present invention may also use oval or non-circular wire conductors, or conductors made of metals having different resistivity/conductivity.

### Preferred Embodiment System Summary

The present invention preferred exemplary system embodiment anticipates a wide variety of variations in the basic theme of construction, but can be generalized as an electrical wiring system comprising:
HOT wire comprising a source end and load end;
NEUTRAL wire comprising a source end and load end; and
GROUND wire comprising a source end and load end;

wherein
the HOT wire is insulated;
the NEUTRAL wire is insulated; and
the GROUND wire has a lower resistance than the HOT wire.

This general system summary may be augmented by the various elements described herein to produce a wide variety of invention embodiments consistent with this overall design description.

### Preferred Embodiment Method Summary

The present invention preferred exemplary method embodiment anticipates a wide variety of variations in the basic theme of implementation, but can be generalized as an electrical wiring method wherein the method utilizes an electrical wiring system comprising:
HOT wire comprising a source end and load end;
NEUTRAL wire comprising a source end and load end; and
GROUND wire comprising a source end and load end;

wherein
the HOT wire is insulated;
the NEUTRAL wire is insulated; and
the GROUND wire has a lower resistance than the HOT wire;

with the method comprising the steps of:
electrically connecting the HOT wire source end to a circuit breaker in an electrical panel;
electrically connecting the NEUTRAL wire source end to a NEUTRAL bus bar in the electrical panel;
electrically connecting the GROUND wire source end to the NEUTRAL bus bar; and
electrically connecting the HOT wire load end, the NEUTRAL wire load end, and the GROUND wire load end to corresponding HOT, NEUTRAL, and GROUND connections in a power outlet supplying electrical power to one or more appliances incorporating a TVSS device.

One skilled in the art will recognize that these method steps may be augmented or rearranged without limiting the teachings of the present invention.

### System/Method Variations

It will be evident to those skilled in the art that there has been described herein an improved method and apparatus for connecting to, and supplying power for, a device or appliance that is protected by certain surge suppression circuits. Although the invention hereof has been described by way of preferred embodiments, it is evident that other adaptations and modifications can be employed without departing from the spirit and scope thereof.

The present invention anticipates a wide variety of variations in the basic theme of construction. The examples presented previously do not represent the entire scope of possible usages. They are meant to cite a few of the almost limitless possibilities. The basic system and method described above may be augmented with a variety of ancillary embodiments, including but not limited to:
An embodiment wherein the GROUND wire has a larger cross-sectional area than the HOT wire.
An embodiment wherein the HOT wire, the NEUTRAL wire, and the GROUND wire are surrounded by a polymer jacket.
An embodiment wherein the GROUND wire is insulated.
An embodiment wherein the NEUTRAL wire has a lower resistance than the HOT wire.
An embodiment wherein the NEUTRAL wire has a larger cross-sectional area than the HOT wire.
An embodiment wherein the NEUTRAL wire and the GROUND wire are at least two AWG sizes larger in cross-sectional area than the HOT wire.
An embodiment wherein the NEUTRAL wire comprises #10 AWG copper wire, the GROUND wire comprises #10 AWG copper wire, and the HOT wire comprises #12 AWG copper wire.
An embodiment wherein the NEUTRAL wire and the GROUND wire are at least four AWG sizes larger in cross-sectional area than the HOT wire.
An embodiment wherein the NEUTRAL wire comprises #10 AWG copper wire, the GROUND wire comprises #10 AWG copper wire, and the HOT wire comprises #14 AWG copper wire.
An embodiment wherein the HOT wire further comprises a plurality of HOT wires.
An embodiment wherein the HOT wire is electrically connected to a TVSS.
An embodiment wherein the NEUTRAL wire is electrically connected to a TVSS.
An embodiment wherein the HOT wire is electrically connected to a circuit breaker.
An embodiment wherein the HOT wire and the NEUTRAL wire are electrically connected to a TVSS.
An embodiment wherein the HOT wire load end and the NEUTRAL wire load end are electrically connected to corresponding HOT and NEUTRAL connections of an electrical load contained within an appliance chassis and the GROUND wire load end is electrically connected to the appliance chassis.
An embodiment wherein the HOT wire source end, the NEUTRAL wire source end, and the GROUND wire source end are electrically connected to corresponding HOT, NEUTRAL, and GROUND connections of an AC three-prong power plug and the HOT wire load end, the NEUTRAL wire load end, and the GROUND wire load end are electrically connected to corresponding HOT, NEUTRAL, and GROUND connections of a surge protector power strip containing a TVSS.

One skilled in the art will recognize that other embodiments are possible based on combinations of elements taught within the above invention description.

### CONCLUSION

An electrical wiring system/method that overcomes dangers associated with transient voltages in electrical system wiring harnesses by controlling the voltage differential between NEUTRAL and GROUND wires with respect to HOT wire(s) within an electrical cable during TVSS faulting conditions has been disclosed. This voltage control minimizes the temporary voltage rise in chassis potential of a grounded appliance that may occur during TVSS operation or during an internal equipment short or GROUND fault condition. The system/method accomplishes this goal by asymmetrically configuring the wiring conductance paths associated with the NEUTRAL or GROUND conductors within the wiring harness and in some preferred embodiments configures the NEUTRAL and GROUND wires to have larger cross sectional areas than the HOT wire(s). The system/method may in some preferred embodiments be advantageously implemented in commercial/residential applications involving alternating current (AC) power distribution and the like.

Though a preferred embodiment of the present invention has been illustrated in the accompanying drawings and described in the foregoing Detailed Description, it will be understood that the invention is not limited to the embodiments disclosed, but is capable of numerous rearrangements, modifications, and substitutions without departing from the spirit of the invention as set forth and defined by the following claims.

What is claimed is:

1. An electrical wiring system comprising:
(a) HOT wire comprising a source end and load end;
(b) NEUTRAL wire comprising a source end and load end; and
(c) GROUND wire comprising a source end and load end;
wherein
said HOT wire is insulated;
said NEUTRAL wire is insulated; and
said GROUND wire has a lower resistance than said HOT wire.

2. The electrical wiring system of claim 1 wherein said GROUND wire has a larger cross-sectional area than said HOT wire.

3. The electrical wiring system of claim 2 wherein said HOT wire, said NEUTRAL wire, and said GROUND wire are surrounded by a polymer jacket.

4. The electrical wiring system of claim 3 wherein said GROUND wire is insulated.

5. The electrical wiring system of claim 4 wherein said NEUTRAL wire has a lower resistance than said HOT wire.

6. The electrical wiring system of claim 5 wherein said NEUTRAL wire has a larger cross-sectional area than said HOT wire.

7. The electrical wiring system of claim 7 wherein said NEUTRAL wire and said GROUND wire are at least two AWG sizes larger in cross-sectional area than said HOT wire.

8. The electrical wiring system of claim 7 wherein said NEUTRAL wire comprises #10 AWG copper wire, said GROUND wire comprises #10 AWG copper wire, and said HOT wire comprises #12 AWG copper wire.

9. The electrical wiring system of claim 6 wherein said NEUTRAL wire and said GROUND wire are at least four AWG sizes larger in cross-sectional area than said HOT wire.

10. The electrical wiring system of claim 9 wherein said NEUTRAL wire comprises #10 AWG copper wire, said GROUND wire comprises #10 AWG copper wire, and said HOT wire comprises #14 AWG copper wire.

11. The electrical wiring system of claim 9 wherein said HOT wire further comprises a plurality of HOT wires.

12. The electrical wiring system of claim 9 wherein said HOT wire is electrically connected to a TVSS.

13. The electrical wiring system of claim 9 wherein said NEUTRAL wire is electrically connected to a TVSS.

14. The electrical wiring system of claim 9 wherein said HOT wire is electrically connected to a circuit breaker.

15. The electrical wiring system of claim 9 wherein said HOT wire and said NEUTRAL wire are electrically connected to a circuit breaker.

16. The electrical wiring system of claim 3 wherein said HOT wire load end and said NEUTRAL wire load end are electrically connected to corresponding HOT and NEUTRAL connections of an electrical load contained within an appliance chassis and said GROUND wire load end is electrically connected to said appliance chassis.

17. The electrical wiring system of claim 3 wherein said HOT wire source end, said NEUTRAL wire source end, and said GROUND wire source end are electrically connected to corresponding HOT, NEUTRAL, and GROUND connections of an AC three-prong power plug and said HOT wire load end, said NEUTRAL wire load end, and said GROUND wire load end are electrically connected to corresponding HOT, NEUTRAL, and GROUND connections of a surge protector power strip containing a TVSS.

18. An electrical wiring method wherein said method utilizes an electrical wiring system comprising:
(a) HOT wire comprising a source end and load end;
(b) NEUTRAL wire comprising a source end and load end; and
(c) GROUND wire comprising a source end and load end;
wherein
said HOT wire is insulated;
said NEUTRAL wire is insulated; and
said GROUND wire has a lower resistance than said HOT wire;
with said method comprising the steps of:
(1) electrically connecting said HOT wire source end to a circuit breaker in an electrical panel;
(2) electrically connecting said NEUTRAL wire source end to a NEUTRAL bus bar in said electrical panel;
(3) electrically connecting said GROUND wire source end to said NEUTRAL bus bar; and
(4) electrically connecting said HOT wire load end, said NEUTRAL wire load end, and said GROUND wire load end to corresponding HOT, NEUTRAL, and GROUND connections in a power outlet supplying electrical power to one or more appliances incorporating a TVSS device.

19. The electrical wiring method of claim 18 wherein said GROUND wire has a larger cross-sectional area than said HOT wire.

20. The electrical wiring method of claim 19 wherein said HOT wire, said NEUTRAL wire, and said GROUND wire are surrounded by a polymer jacket.

21. The electrical wiring method of claim 20 wherein said GROUND wire is insulated.

22. The electrical wiring method of claim 21 wherein said NEUTRAL wire has a lower resistance than said HOT wire.

23. The electrical wiring method of claim 22 wherein said NEUTRAL wire has a larger cross-sectional area than said HOT wire.

24. The electrical wiring method of claim 24 wherein said NEUTRAL wire and said GROUND wire are at least two AWG sizes larger in cross-sectional area than said HOT wire.

25. The electrical wiring method of claim 24 wherein said NEUTRAL wire comprises #10 AWG copper wire, said GROUND wire comprises #10 AWG copper wire, and said HOT wire comprises #12 AWG copper wire.

26. The electrical wiring method of claim 23 wherein said NEUTRAL wire and said GROUND wire are at least four AWG sizes larger in cross-sectional area than said HOT wire.

27. The electrical wiring method of claim 26 wherein said NEUTRAL wire comprises #10 AWG copper wire, said GROUND wire comprises #10 AWG copper wire, and said HOT wire comprises #14 AWG copper wire.

28. The electrical wiring method of claim 26 wherein said HOT wire further comprises a plurality of HOT wires.
